(19) United States
(12) Patent Application Publication
(10) Pub. No.: US 2011/0234793 A1
(43) Pub. Date: Sep. 29, 2011

(54) DIGITAL SECURITY MONITORING SYSTEM

(75) Inventors: Mao Huai Weng, Taipei Hsien (TW); Wen Chu Chuang, Taipei Hsien (TW); Hsuan Hung Tai, Taipei Hsien (TW)

(73) Assignee: ACARD Technology Corp., Taipei Hsien (TW)

(21) Appl. No.: 12/855,824

(22) Filed: Aug. 13, 2010

(30) Foreign Application Priority Data
Mar. 24, 2010 (TW) 099205148

(51) Int. Cl. H04N 7/18

(52) U.S. Cl. 348/143; 348/E07.085

(57) ABSTRACT

A digital security monitoring system includes a main control unit, at least one camera, and a recording unit. The at least one camera is electrically connected to the main control unit. The main control unit is also electrically connected to the recording unit which includes a robotic arm, at least two optical disc recorders, and an optic disc storage area. The mentioned optical disc recorders and the optic disc storage area are arranged at a location adjacent to the robotic arm to allow the robotic arm to access the optic disc storage area and also to allow the at least two optical disc recorders to carry out uninterrupted disc recording operations. Thus, it provides a real-time recording of video data from the camera, non-interrupted recording operation, extended time of video data protection, easy filing and management and timely displaying of data, etc.

### BACKGROUND OF THE INVENTION

1. Field of the Invention

The present invention is related to a digital security monitoring system, and more particular to one that is composed of a main control unit, at least one camera, and a recording unit to provide advantages in association with real-time recording of the video data from the camera, non-interrupted recording, extended preservation time for video data, convenient management and filing, and timely displaying of video data for applications in various digital security monitoring systems or similar monitoring system.

2. Description of Related Art

A conventional digital security monitoring system that is available in is the market is generally composed of a main control unit, at least one camera, and a hard disc drive. The camera and the hard disc drive are set in electrical connection with the main control unit to realize security monitoring for the site where the system is installed. However, the effectiveness of security monitoring provided by such a conventional system is constrained by the limited capacity of storage of the hard disc drive. Once the recorded video data exceeds the storage capacity of the hard disc drive, over-writing of data will be performed, whereby video data that were recorded long ago are often not available for reviewing. Further, the recorded data are susceptible to unauthorized modification and deletion when the data are backed up, resulting to poor security performance and functionality. Further, those data recorded in the hard disc drive are hard to manage and organize for filing. Thus, the known system is not completely fit the needs of the general consumers.

### SUMMARY OF THE INVENTION

An objective of the present invention is to provide a digital security monitoring system, which comprises a main control unit, at least one camera, and a recording unit, wherein the recording unit comprises a robotic arm, at least two optical disc recorders, and an optic disc storage area. The two optical disc recorders and the optic disc storage area are set adjacent to the robotic arm, whereby the robotic arm may access optic discs stored in the optic disc storage area and the two optical disc recorders may carry out successive disc recording operations. Since data storage is realized through recording of optic discs, the data can be protected from unauthorized modification and deletion during a back-up process of the data and the time in which the recorded data are preserved can be extended to as long as for example centuries and undesired over-writing of the data due to over-long time lapse can be avoided. Thus, the present invention can significantly improve the overall operation functionality and security performance due to adoption of optic discs as primary recording medium.

Another objective of the present invention is to provide a digital security monitoring system that comprises a recording unit comprising a robotic arm, at least two optical disc recorders, and a optic disc storage area, whereby with the at least two optical disc recorders and the optic disc storage area being arranged adjacent to the robotic arm, when one of the optical disc recorders is being in recording operation, the robotic arm may move a blank optic disc that is provided in advance into another one of the optical disc recorders so that once the recording operation is done, said another optical disc recorder is immediately put into operation to continue recording of video data so as to ensure a non-interrupted video data recording process thereby realizing complete functionality of the present invention and integrity and continuity of data recording.

A further objective of the present invention is to provide a digital security monitoring system, which comprises a main control unit that is selectively connectable to a hard disc drive to allow the system of the present invention to be selectively configured with an existing monitoring system, providing the monitoring system of the present invention with additional storage thereby improving overall functionality and expandability of the present invention.

Yet a further objective of the present invention is to provide a digital security monitoring system, which comprises a recording unit that is selectively set up in a remote secured site and wherein the optic discs in which video data for monitoring purposes are recorded can be kept by specified personnel to protect the video data file from potential risks of malign destruction, stealing, and damage thereby further ensuring performance functionality of the present invention and data integrity.

In order to achieve the foregoing objectives, the present invention provides a digital security monitoring system, which comprises a main control unit, at least one camera, and a recording unit. The at least one camera is electrically connected to the main control unit. The main control unit is also electrically connected to the recording unit. The recording unit comprises a robotic arm, at least two optical disc recorders, and an optic disc storage area. The at least two optical disc recorders and the optic disc storage area are arranged adjacent to the robotic arm to allow the robotic arm to access optic discs stored in the optic disc storage area and also to allow the at least two optical disc recorders to carry out successive disc recording operations. As such, advantages associated with protection of the recorded video file contents from unauthorized modification and deletion in a data back-up process, extended time of preservation of recorded data, protection of recorded video data files from malign destruction, stealing, and damage, easy management and organization of the recorded video files of optic discs, and selective combination with existing hard disc drives can be realized to thereby enhance the overall practicability, functionality, and security performance.

### BRIEF DESCRIPTION OF THE DRAWINGS

The present invention can be fully understood from the following is detailed description and preferred embodiment with reference to the accompanying drawings, in which:

FIG. 1 is a perspective view illustrating an embodiment of the present invention;

FIG. 2 is a block diagram illustrating an embodiment of the present invention;

FIG. 3 is a top plan view illustrating an operation of the present invention; and

FIG. 4 is a side elevational view illustrating an operation of the present invention.

### DETAILED DESCRIPTION OF THE PREFERRED EMBODIMENTS

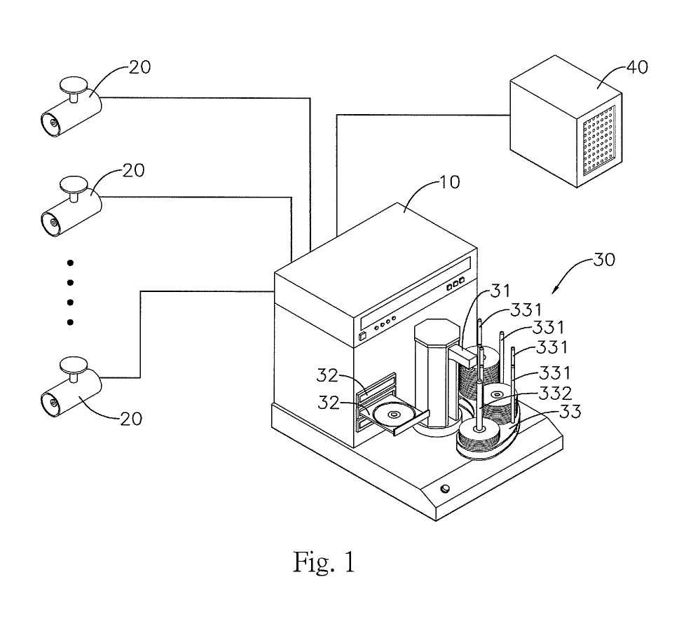

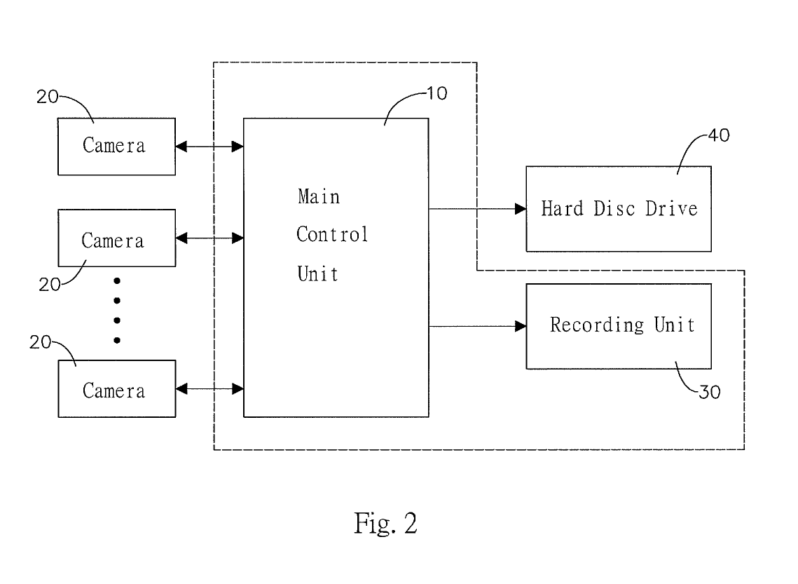

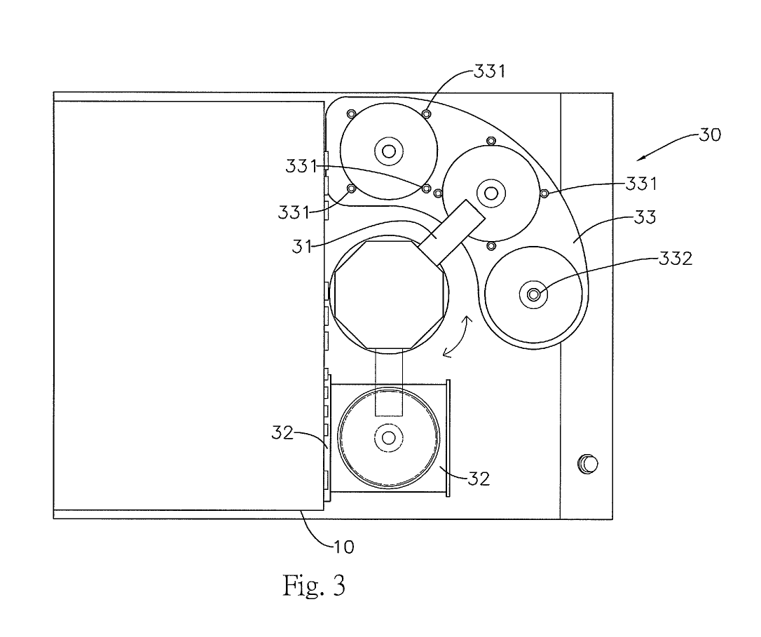

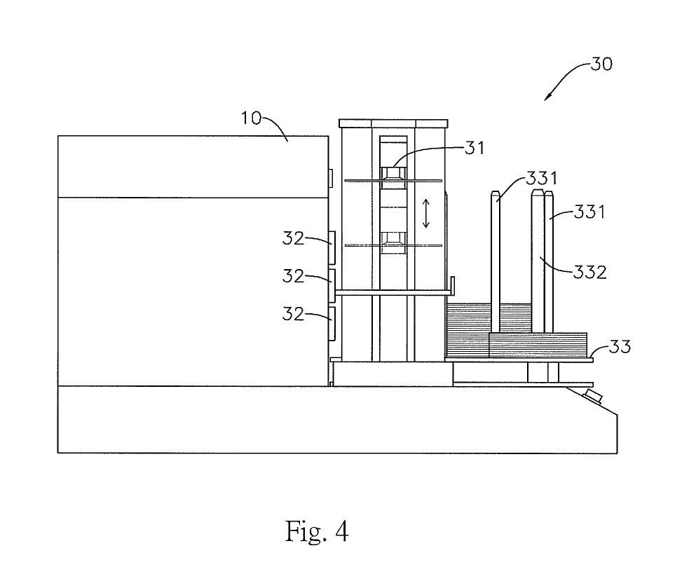

Referring to FIGS. 1-4, the present invention provides a digital security monitoring system comprising the following constituent components.

A main control unit 10 functions to control activation/deactivation and operation mode of the system, and stores starting and ending time points of system burning/recording operation and related data through input operation.

At least one camera 20 is provided and is in electrical connection with the main control unit 10.

A recording unit 30 is also electrically connected to the main control unit 10. The recording unit 30 comprises a robotic arm 31, at least two optical disc recorders 32, and an optic disc storage area 33. The two optical disc recorders 32 and the optic disc storage area 33 are arranged adjacent to the robotic arm 31, whereby the robotic arm 31 may access optic discs stored in the optic disc storage area 33 and the two optical disc recorders 32 may carry out successive disc recording operations. The optic disc storage area 33 has an end portion on which a plurality of holding rods 331 is mounted to provide a to-be-recorded disc zone and another end portion on which a fixing rod 332 is mounted to provide a recorded disc holding zone.

With the arrangement described above, a digital security monitoring system is provided. As shown in FIGS. From 1 to 4, the present invention is characterized by an assembly of a main control unit 10, at least one camera 20, and a recording unit 30; and at least two optical disc recorders 32 and a optic disc storage area 33 are arranged adjacent to a robotic arm 31 to allow the robotic arm 31 to access optic discs stored in the optic disc storage area 33 and also to allow the at least two optical disc recorders 32 to carry out successive optic disc recording operations. To put the present invention into practical operation, a user first positions blank optic discs into a to-be-recorded disc zone that is provided by a plurality of holding rods 331 mounted at an end portion of the optic disc storage area 33. Before video recording starts, the robotic arm 31 moves and deposits blank optic discs into the two optical disc recorders 32 and monitoring is taken when video recording starts to ensure video data are burnt to the optic disc loaded in the first optical disc recorder 32 until the recording operation performed on the optic disc is completed. Afterwards, the second optical disc recorder 32 immediately and successively starts the recording operation of video data on the optic disc loaded therein. Meanwhile, the robotic arm 31 retrieves and conveys the burning-completed optic disc to the optic disc storage area 33 for fitting the optic disc onto the fixing rod 332 and then the robotic arm 31 picks up a new blank optic disc and conveys and deposits the new blank optic disc into the first optical disc recorder. Once the recording operation carried out in the second optical disc recorder 32 is completed, this same process will be repeated and so on. In this way, successive recording operations can be alternately carried out by the at least two optical disc recorders 32 and as a result, the present invention provides the advantages of excellent performance of digital security monitoring, extended time of preservation of recoded video data, and easy management and organization of data for filing, and improves overall practicability, security performance, and functionality.

Further, the present invention allows the main control unit 10 to be operatively combined with an existing monitoring system by electrically connecting with a hard disc drive 40, which provides additional data storage to the system of the present invention with further improved system functionality and expandability.

Further, the present invention allows the recording unit 30 to be set up in a remote secured site and the optic discs in which video data for monitoring purposes are recorded can be kept by specified personnel to protect the video data file from potential risks of malign destruction, stealing, and damage thereby further ensuring performance functionality of the present invention and data integrity.

Further, the present invention allows immediate printing of starting and ending time points of the recording time and related data on a surface of the optic disc, so that management and organization of the video data files recorded in the burning-completed optic discs are made easy and convenient.

In summary, the present invention provides various advantages in association with excellent digital security monitoring function, extended time of preservation of recorded video data, easy management and organization for filing, and capability of combination with existing storage of hard disk drive and improves the overall practicability, security performance, and convenience.

What is claimed is:

1. A digital security monitoring system, comprising:
a main control unit;
at least one camera, which is electrically connected to the main control unit; and
a recording unit, which is electrically connected to the main control unit and comprises a robotic arm, at least two optical disc recorders, and an optic disc storage area, the at least two optical disc recorders and the optic disc storage area being arranged adjacent to the robotic arm to allow the robotic arm to access optic discs stored in the optic disc storage area and also to allow the at least two optical disc recorders to carry out uninterrupted disc recording operations.

2. The digital security monitoring system according to claim 1, wherein the optic disc storage area has an end portion on which a plurality of holding rods are mounted to provide a to-be-recorder disc zone and another end portion on which a fixing rod is mounted to provide a recorded disc holding zone.

3. The digital security monitoring system according to claim 1, wherein the main control unit is electrically connected to a hard disc drive.
